(19) United States
(12) Patent Application Publication
(10) Pub. No.: US 2002/0074944 A1
(43) Pub. Date: Jun. 20, 2002

(54) Mixed discharge gas of plasma display panel

(75) Inventors: Insook Lee, Kyonggi-do (KR); Seong Ju Yoon, Seoul (KR); Sung Chun Choi, Kyonggi-do (KR)

Correspondence Address: FLESHNER & KIM, LLP, P.O. Box 221200, Chantilly, VA, 20153-1200, US

(73) Assignee: LG Electronics Inc.

(21) Appl. No.: 10/012,487

(22) Filed: Dec. 12, 2001

(30) Foreign Application Priority Data
Dec. 14, 2000 (KR) P2000-76520

(51) Int. Cl. H01J 17/20; H01J 61/16

(52) U.S. Cl. 313/643

(57) ABSTRACT

A mixed discharge gas of a PDP is disclosed, which includes at least one inert gas. At this time, Xe is contained at a ratio of 3˜20% in the mixed discharge gas, and a pressure is kept between 300 torr and 700 torr, thereby enhancing efficiency and a life span of the PDP.

This application claims the benefit of the Korean Application No. 2000-0076520 filed on Dec. 14, 2000, which is hereby incorporated by reference.

### BACKGROUND OF THE INVENTION

1. Field of the Invention

The present invention relates to a plasma display panel (PDP), and more particularly, to a mixed discharge gas of the PDP.

2. Discussion of the Related Art

In general, a PDP has been attracted as an advanced display device due to characteristics such as high resolution, variety of a panel size, thinness and lightness in weight.

However, the PDP still has technical problems to solve. For examples, the PDP has difficulties to manufacture a large sized display panel, to obtain fineness of display quality, to improve luminance and contrast ratio, to decrease power consumption and manufacturing cost, and to obtain good display quality in moving pictures.

Especially, it is most important to manufacture the PDP obtaining high luminance with low power consumption.

FIG. 1 is a perspective view showing a structure of a general PDP.

As shown in FIG. 1, the general PDP includes lower and upper panels 40 and 20.

The upper panel 20 includes scan and sustain electrodes 22 and 23, a dielectric layer 31, and a passivation layer 32. The scan and substrate electrodes 22 and 23 are formed on an upper glass substrate 21. Then, the dielectric layer 31 and the passivation layer 32 are sequentially formed on the upper panel 20 including the scan and sustain electrodes 22 and 23.

At this time, the scan and sustain electrodes 22 and 23 includes transparent electrodes 22-1 and 23-1, and bus electrodes 22-2 and 23-2 on the transparent electrodes 22-1 and 23-1, respectively.

The lower panel 40 includes address electrodes 42, a dielectric layer 43, barriers 45, and a phosphor 44.

The address electrodes 42 are formed on a lower glass substrate 41 corresponding to portions that are perpendicular to the scan and sustain electrodes 22 and 23. Then, the dielectric layer 43, the barriers 45 and the phosphor 44 are formed on the lower glass substrate 41 including the address electrodes 42.

The lower and upper panels 40 and 20 are attached to each other. Then, inert gases such as He and Xe are injected in a space between the lower and upper panels 40 and 20.

In general, the mixed gas of He and Xe is injected in a discharge area of a direct current DC PDP, and mixed gas of Ne and Xe is injected in a discharge area of an alternating current AC PDP.

An operation of the aforementioned PDP will now be described.

If a driving voltage is applied between each address electrode and each scan electrode, opposite discharge occurs between the address and scan electrodes. Some ions emitted from the inert gas within the discharge cell come into collision with a surface of the passivation layer due to the opposite discharge. The collision of the ions secondarily emits electrons from the surface of the passivation layer. The secondarily emitted electrons come into collision with a plasma gas to diffuse the discharge. If the opposite discharge between the address and scan electrodes ends, wall charges having opposite polarities occur on the surface of the passivation layer on the respective address and scan electrodes.

If the discharge voltages having opposite polarities are continuously applied to the scan and address electrodes, at the same time, the driving voltage applied to the address electrode is cut off, area discharge occurs in a discharge area on the surfaces of the dielectric layer and the passivation layer due to the potential difference between the scan and address electrodes. The electrons in the discharge cell come into collision with the inert gas in the discharge cell due to the opposite discharge and the area discharge. As a result, the inert gas in the discharge cell is excited and ultraviolet rays occur in the discharge cell. The ultraviolet rays come into collision with the phosphors surrounding the address electrode and the barriers, so that the ultraviolet rays are emitted, thereby displaying a picture image.

A procedure for obtaining the picture image is more complicate in the PDP than in a CRT, so that efficiency of the PDP is lower than that of the CRT.

If a mixed discharge gas having high efficiency is developed in the PDP even though emitting procedure of light is complicate, it will be possible to enhance high efficiency in the PDP.

Partially, a life span of the PDP is determined according to the passivation layer etch by gas ions, and the phosphor degradation. However, the mixed discharge gas mainly determines the life span of the PDP.

Accordingly, if conditions such as a sort, content and a pressure of the mixed discharge gas are kept at an appropriate range, the life span of the PDP can considerably be lengthened.

### SUMMARY OF THE INVENTION

Accordingly, the present invention is directed to a mixed discharge gas of a PDP that substantially obviates one or more problems due to limitations and disadvantages of the related art.

An object of the present invention is to provide a mixed discharge gas of a PDP that can lengthen a life span of a PDP by adjusting a composition ratio and a pressure of the mixed discharge gas.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mixed discharge gas of a PDP according to the present invention includes at least one inert gas, which contains Xe at a ratio of 3˜20%.

At this time, a pressure of the mixed discharge gas is kept between 300 torr and 700 torr.

The mixed discharge gas includes at least one of He, Ne and Ar.

A life span of the PDP can lengthen by the mixed discharge gas that satisfies the above conditions.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a structure of a general PDP;

FIG. 2 is a graph illustrating efficiency and a breakdown voltage according to content of Xe in a mixed discharge gas of the present invention;

FIG. 3 is a graph illustrating efficiency and a breakdown voltage according to pressure of a mixed discharge gas;

FIG. 4 is a graph illustrating efficiency of a PDP according to a mixed discharge gas in various conditions; and

FIG. 5 is a chart illustrating a life span of a PDP according to a mixed discharge gas in various conditions.

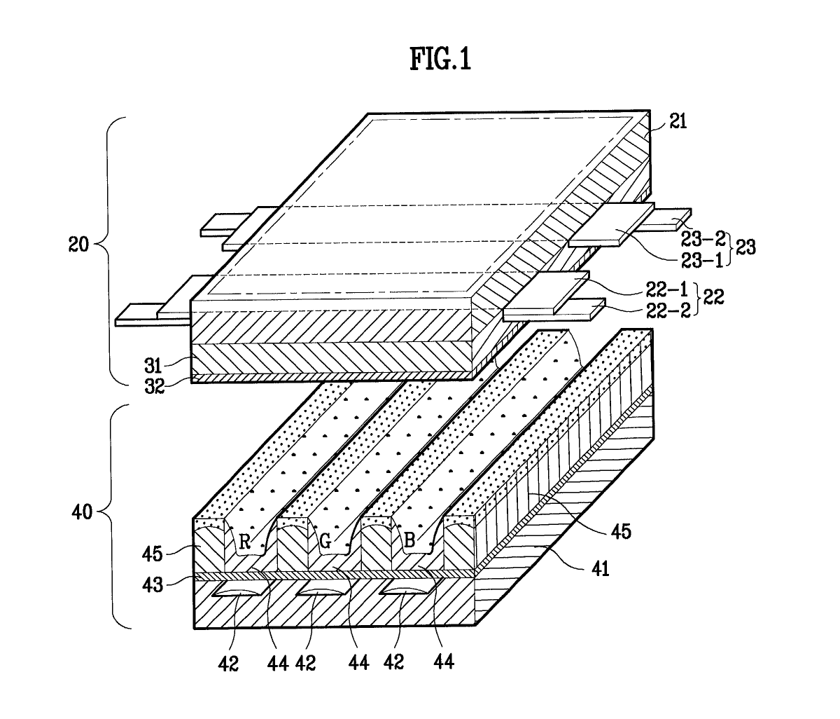

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A mixed discharge gas of a PDP according to the embodiments of the present invention will be described with reference to the accompanying drawings.

In the present invention, content of Xe in the mixed discharge gas and a pressure of the mixed discharge gas are higher than a related art, thereby enhancing efficiency of the PDP.

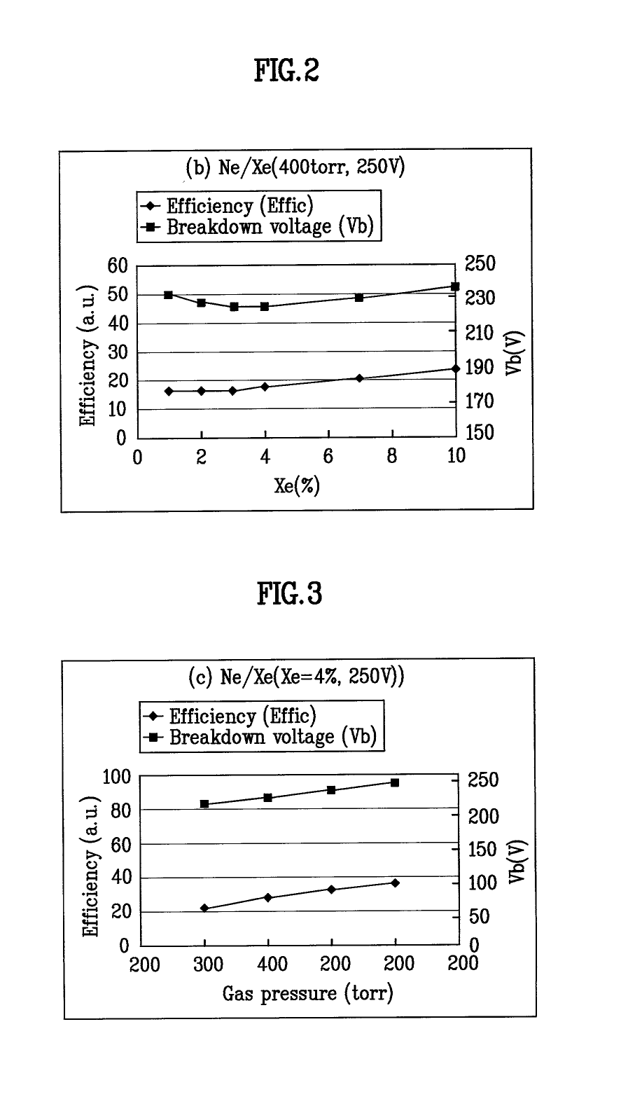

As shown in FIG. 2, changes of a breakdown voltage and efficiency are illustrated according to changes of the content of Xe in the mixed discharge gas. In this graph, it is shown how the content of Xe in the mixed discharge gas affects the breakdown voltage and efficiency.

At this time, Ne and Xe are contained in the mixed discharge gas. Also, the mixed discharge gas is kept at a pressure of 400 torr, and at a driving voltage of 250 V.

As a result, efficiency of the PDP is increased as the content of Xe is increased in the mixed discharge gas of Xe/Ne.

However, as the content of Xe becomes high, the breakdown voltage becomes high. Also, as the content of Xe becomes low, the breakdown voltage becomes low. Therefore, the content of Xe has to be kept at an appropriate range.

In the present invention, Xe is contained at a ratio of 3˜20%, in which the PDP is most efficient.

Or, if the mixed discharge gas in which Xe is contained at a ratio of 3˜20% is used with a passivation layer having a high secondary electron emitting coefficient to Xe, efficiency of the PDP may be enhanced due to a low driving voltage.

Referring to FIG. 3, the pressure of the mixed discharge gas is changed to illustrate changes of the efficiency of the PDP and the breakdown voltage. As shown in FIG. 3, changes of a breakdown voltage and efficiency are illustrated according to pressure changes of the mixed discharge gas. In this graph, it is shown how the pressure of the mixed discharge gas affects the breakdown voltage and efficiency.

At this time, the mixed discharge gas in which Ne and Xe are contained is used, and Xe is contained at a ratio of 4% in the mixed discharge gas. A driving voltage is kept at 250 V.

As a result, as the pressure of Ne/Xe mixed discharge gas becomes high, efficiency of the PDP is enhanced.

However, if the pressure of the mixed gas becomes too high, the breakdown voltage becomes too high, also, if the pressure of the mixed gas becomes too low, the breakdown voltage becomes too low. Therefore, it is important to keep the pressure of the mixed gas at an appropriate range.

In the present invention, the pressure of the mixed gas is kept between 300 torr and 700 torr, in which the PDP is most efficient.

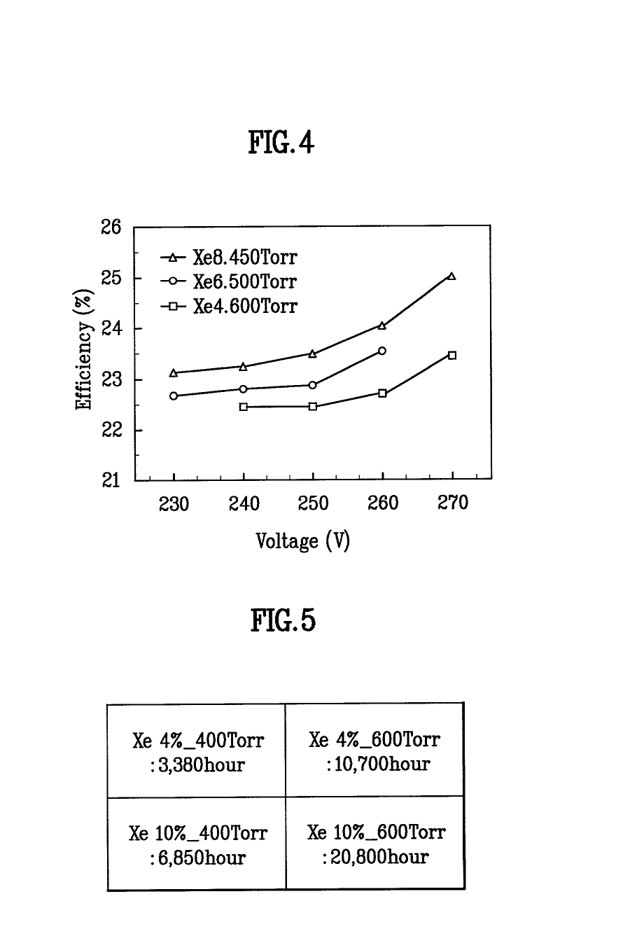

FIG. 4 is a graph illustrating efficiency of the PDP according to the mixed discharge gas in various conditions.

At this time, the mixed discharge gas in which Ne and Xe are contained is used. Firstly, the mixed discharge gas in which Xe is contained at a ratio of 4% is used, and the pressure of the mixed discharge gas is at 600 torr. Secondly, the mixed discharge gas in which Xe is contained at a ratio of 6%, and the pressure of the mixed discharge gas is at 500 torr. Thirdly, the mixed discharge gas in which Xe is contained at a ratio of 8%, and the pressure of the mixed discharge gas is at 450 torr.

As shown in FIG. 4, it is more efficient to increase the content of Xe at 2% and to decrease the pressure of the mixed discharge gas at 50 torr than to decrease the content of Xe at 2%2 and to increase the pressure of the mixed discharge gas at 50 torr.

That is, as the content of Xe and the pressure of the mixed discharge gas are increased, the driving voltage is increased as well as efficiency.

If increased values of each mixed discharge gas are equal, it is more efficient to increase the content of Xe in the mixed discharge gas than to increase the pressure of the mixed discharge gas.

In the present invention, Xe is contained at a ratio of 3˜20% in the mixed discharge gas, and the pressure of the mixed discharge gas is kept between 300 torr and 700 torr, thereby enhancing efficiency.

At this time, the mixed discharge gas includes at least one of inert gases such as He, Ne and Ar.

The present invention can lengthen a life span of the PDP.

FIG. 5 is a graph illustrating the life span of the PDP according to the mixed discharge gas in various conditions.

As shown in FIG. 5, if the content of Xe in the mixed discharge gas and the pressure of the mixed gas are increased within a particular range, the life span of the PDP is lengthened.

That is, if the pressure of the mixed discharge gas is increased, collision between gases becomes severe, so that the electrons do not have sufficient energy for ionizing gas atoms. Therefore, energy of ions are decreased, thereby decreasing an etch ratio for the passivation layer.

If the content of Xe is increased, the number of Xe ions is severely increased in the discharge cell more than the number of Ne ions.

A sputtering yield of the Xe ions is smaller than that of the Ne ions, thereby increasing the life span of the passivation layer.

Accordingly, as the content of Xe in the mixed discharge gas and the pressure of the mixed discharge gas are increased, the life span of the PDP is lengthened.

However, if the content of Xe becomes higher than 20 percentages, charge transfers between Xe ions and Xe atoms become easier. Meanwhile, charge transfers between Ne ions and Ne atoms become more difficult.

That is, energy of Ne ions that reaches the passivation layer is increased, and the sputtering yield of ions is increased, thereby shortening the life span of the PDP.

Accordingly, it is most efficient to contain Xe at a ratio of 3˜20% and the keep the pressure of the mixed discharge gas between 300 torr and 700 torr.

As mentioned above, the mixed discharge gas of the PDP has the following advantages.

First, the life span of the PDP can be lengthened by a chemically stabilized inert gas.

Additionally, it is possible to obtain high luminance by a gas emitting strong vacuum ultra violet (VUV).

Next, a color purity can be enhanced by a gas emitting little visible rays.

Furthermore, an optical transfer ratio to visible rays can be high in the VUV by a gas emitting VUV of a long wavelength.

Also, since a mixed gas keeping discharge at a low voltage is used, power consumption can be decreased, thereby improving efficiency.

Finally, the mixed discharge gas is formed under the most efficient conditions of a composition ratio, a sort, and pressure of the mixed discharge gas, thereby solving problems such as low luminance and short life span generated in a color AC PDP.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A mixed discharge gas of a PDP comprising at least one inert gas, the mixed discharge gas containing Xe at a ratio of 3˜20%.

2. The mixed discharge gas of the PDP as claimed in claim 1, wherein a pressure of the mixed discharge gas is kept between 300 torr and 700 torr.

3. The mixed discharge gas of the PDP as claimed in claim 1, wherein the mixed discharge gas includes He.

4. The mixed discharge gas of the PDP as claimed in claim 1, wherein the mixed discharge gas includes Ne.

5. The mixed discharge gas of the PDP as claimed in claim 1, wherein the mixed discharge gas includes Ar.

6. The mixed discharge gas of the PDP as claimed in claim 1, wherein the mixed discharge gas includes at least one of He, Ne and Ar.
